(19) United States
(12) Patent Application Publication
(10) Pub. No.: US 2023/0180354 A1
(43) Pub. Date: Jun. 8, 2023

(54) WATER-BASED HEAT-GENERATING COATING MATERIAL AND PLANAR HEAT-GENERATING ELEMENT

(71) Applicant: SAKAGUCHI E.H. VOC CORP., Chiyoda-ku, Tokyo (JP)

(72) Inventor: Emi YAMAMORI, Chiyoda-ku, Tokyo (JP)

(21) Appl. No.: 17/912,768

(22) PCT Filed: Apr. 5, 2021
(86) PCT No.: PCT/JP2021/014503

§ 371 Date: Sep. 19, 2022

(30) Foreign Application Priority Data
Apr. 10, 2020 (JP) 2020-071308

(51) Int. Cl. H05B 3/14; H05B 3/34

(52) U.S. Cl. CPC H05B 3/146; H05B 3/148; H05B 3/34

(57) ABSTRACT

An object is to provide a water-based heat-generating coating material that can generate high-temperature heat and a planar heat-generating element that includes a resistance heat-generating layer formed by applying the water-based heat-generating coating material. As a solution, a water-based heat-generating coating material is provided that includes a conductive material, a binder resin, and water-swellable synthetic mica, and contains the water-swellable synthetic mica by 3 parts by weight or more and 40 parts by weight or less relative to 100 parts by weight of solid content, as well as a planar heat-generating element that includes a resistance heat-generating layer formed by applying the water-based heat-generating coating material.

### TECHNICAL FIELD

The present invention relates to a water-based heat-generating coating material and a planar heat-generating element including a resistance heat-generating layer formed by applying the water-based heat-generating coating material.

### BACKGROUND ART

Planar heat-generating elements including a resistance heat-generating layer formed by applying a heat-generating coating material containing conductive particles, such as carbon black, and a binder resin are utilized in various fields including, for example, floor heating, defrosting, stair snow melting, and pipe heaters (refer to Patent Literatures 1 to 3).

It is known that such a resistance heat-generating layer has positive temperature coefficient (PTC) properties whose resistance value increases as the temperature rises. This is because the binder resin expands as the temperature rises, causing the distance between the conductive particles to be increased. Due to the PTC properties, the resistance value of the resistance heat-generating layer is increased as the temperature rises, which hinders the flow of current. Thus, the resistance heat-generating layer is excellent in terms of safety and energy-savings since the temperature does not rise over a certain temperature. Unfortunately, on the other hand, since the temperature of the resistance heat-generating layer cannot rise over a certain temperature, the resistance heat-generating layer cannot be applied to fields that require heating to a high temperature (for example, 100° C. or higher).

### BACKGROUND ART LITERATURE

### Patent Literature

Patent Literature 1: Japanese Patent Laid-open No. 2014-2841
Patent Literature 2: Japanese Patent Laid-open No. S63-69183
Patent Literature 3: Japanese Patent Laid-open No. H8-31552

### SUMMARY OF THE INVENTION

### Problems to be Solved by the Invention

An object is to provide a water-based heat-generating coating material that can generate high-temperature heat, and a planar heat-generating element that includes a resistance heat-generating layer formed by applying the water-based heat-generating coating material.

### Means for Solving the Problems

The present invention has been proposed to solve the problem. To be specific, the present invention encompasses the following.

1. A water-based heat-generating coating material characterized by comprising a conductive material, a binder resin, and water-swellable synthetic mica,

wherein the water-swellable synthetic mica is contained by 3 parts by weight or more and 40 parts by weight or less relative to 100 parts by weight of solid content.

2. The water-based heat-generating coating material according to 1, characterized in that the conductive material is contained by 30 parts by weight or more and 70 parts by weight or less, and the binder resin is contained by 15 parts by weight or more and 50 parts by weight or less relative to 100 parts by weight of solid content.

3. The water-based heat-generating coating material according to 1 or 2; the binder resin is any one or more of a polyimide resin, a silicone resin, and a polyamide resin.

4. A planar heat-generating element having a resistance heat-generating layer comprising the water-based heat-generating coating material according to any one of 1 to 3.

5. The planar heat-generating element according to 4, characterized in that:

the resistance heat-generating layer includes at least two low-resistance regions and at least one high-resistance region, and

a lead wire is connected to the low-resistance regions.

6. The planar heat-generating element according to 5, characterized in that a film thickness of the low-resistance regions is thinner than a film thickness of the high-resistance region.

7. The planar heat-generating element according to any of claims 4 to 6, characterized in that the resistance heat-generating layer is a single coating layer.

### Effects of the Invention

The water-based heat-generating coating material of the present invention has low PTC properties and excellent heat resistance, and thus forms a resistance heat-generating layer that can generate heat over 100° C. or even 200° C. for a long period. The resistance heat-generating layer is apt to cause a failure at the connecting portion with a lead wire where the temperature easily becomes high. However, connecting the lead wire to the low-resistance regions makes faults at the connecting portion unlikely, and thus a highly reliable planar heat-generating element is provided. The resistance value (amount of heat generation) of the resistance heat-generating layer of the present invention can be adjusted by the pressing pressure.

### BRIEF DESCRIPTION OF THE DRAWINGS

FIG. 1 Images of surfaces of resistance heat-generating layers obtained by Experiment 2.

FIG. 2 A graph showing the relationship between a pressing pressure and a resistance value of the resistance heat-generating layers obtained by Experiment 2.

FIG. 3 A graph showing the relationship between the pressing pressure and the resistance value of the resistance heat-generating layers obtained by Experiment 2.

FIG. 4 Thermography of planar heat-generating elements obtained by Experiment 3 when current is supplied.

FIG. 5 A cross-sectional image of the section where a lead wire is located in a resistance heat-generating layer of a planar heat-generating element obtained using a water-based heat-generating coating material of the present invention by Experiment 3.

FIG. 6 A cross-sectional image of the section where a lead wire is located in a resistance heat-generating layer of a planar heat-generating element obtained by Experiment 5.

FIG. 7 An image of a surface of a planar heat-generating element produced by Experiment 6 and a schematic cross-sectional view.

FIG. 8 Cross-sectional images of a section where a SUS foil is located in a planar heat-generating element obtained by Experiment 6.

### MODE FOR CARRYING OUT THE INVENTION

Water-Based Heat-Generating Coating Material

A water-based heat-generating coating material of the present invention contains a conductive material, a binder resin, and water-swellable synthetic mica, and is characterized in that the content of the water-swellable synthetic mica is 3 parts by weight or more and 40 parts by weight or less relative to 100 parts by weight of solid content.

The water-based heat-generating coating material of the present invention will be described in detail below.

### (Conductive Material)

The conductive material may be any material, without particular restrictions, that can be applied as a resistance heat-generating layer of a planar heat-generating element and may be, for example, carbon black, graphite, carbon nanotubes, fullerenes, carbon fiber, and other carbon-based conductive materials, gold, silver, copper, nickel, or other metal-based conductive materials, tungsten carbide, titanium nitride, zirconium nitride, titanium carbide, or other ceramic-based conductive materials. Among these conductive materials, carbon-based conductive materials are preferred because they are available in small particle sizes at a low cost. Any one type of these conductive materials may be used alone, or two or more types may be combined.

The water-based heat-generating coating material of the present invention preferably contains the conductive material at a ratio of 30 parts by weight or more and 70 parts by weight or less relative to 100 parts by weight of solid content.

### (Binder Resin)

Binder resin may be any resin, without particular restrictions, that can dissolve or be dispersed in a water-based coating material, and examples include polyimide resin, silicone resin, polyamide resin, polyurethane resin, polyester resin, acrylic resin, vinyl-based resin, and epoxy resin. Any one type of these binder resins may be used alone, or two or more types may be combined. Among these binder resins, any one or more of polyimide resin, silicone resin, and polyamide resin are preferred because of their excellent heat resistance.

The water-based heat-generating coating material of the present invention preferably contains the binder resin at a ratio of 15 parts by weight or more and 50 parts by weight or less relative to 100 parts by weight of solid content.

### (Water-Swellable Synthetic Mica)

The water-based heat-generating coating material of the present invention contains water-swellable synthetic mica. Since synthetic mica has a small[low] content of impurities such as metal ions, and has a stable quality, it imparts high reliability to the resistance heat-generating layer. In contrast, natural mica has an unstable quality and sometimes contains many impurities. Using natural mica that contains many impurities may cause the resistance value of the resistance heat-generating layer to vary and result in, for example, abnormal heat generation or a short circuit. Additionally, since water-swellable synthetic mica is hydrophilic and is free of unnecessary surface treatment or other treatments, its heat resistance remains unchanged at approximately 600° C. In contrast, with lipophilic synthetic mica, a surface treatment agent or such an agent that imparts the lipophilicity may undesirably be dissolved at approximately 180° C.

Water-swellable synthetic mica absorbs water between its layers and swells. And, the coating material containing swelled mica exhibits a thixotropic property where the viscosity decreases when shear stress is applied, and increases when the stress is removed. The water-based heat-generating coating material of the present invention, which is the water-based coating material containing the water-swellable synthetic mica, exhibits the thixotropic property, is easily applied, and is resistant to liquid dripping after application. The water-based heat-generating coating material of the present invention contains the water-swellable synthetic mica at a ratio of 3 parts by weight or more and 40 parts by weight or less relative to 100 parts by weight of solid content. When the content of the water-swellable synthetic mica is less than 3 parts by weight, the thixotropic property may decrease, which may decrease the ease of coating. When the content of the water-swellable synthetic mica is more than 40 parts by weight, the obtained film may become brittle. Also, since a lot of water is absorbed between the layers of mica, a large amount of water is required to retain the fluidity of the coating material, which reduces the solid content concentration of the coating material. This increases the amount of energy required for drying.

The average particle size (median diameter) of the water-swellable synthetic mica is preferably 2 μm or more and 20 μm or less. The average particle size is derived from the volumetric distribution measured by a laser diffraction method. When the average particle size is in the above range, it has excellent dispersibility in the heat-generating coating material, is excellent in the ease of coating, and is likely to form a uniform coating film. The average particle size is more preferably 2 μm or more and 10 μm or less.

The solid content concentration of the water-based heat-generating coating material of the present invention is adjusted to achieve a viscosity suitable for, for example, its coating method. The solid content concentration may be, for example, approximately 5% by weight or more and 50% by weight or less depending on, for example, the required viscosity.

To the extent that it does not hinder the effect of the present invention, additives such as a dispersant, a leveling agent, a defoaming agent, or a curing agent may be added to the water-based heat-generating coating material of the present invention.

Planar Heat-Generating Element

The planar heat-generating element of the present invention includes the resistance heat-generating layer constituted by the above-mentioned water-based heat-generating coating material. The resistance heat-generating layer may be formed by, for example, applying the water-based heat-generating coating material or by impregnation with the water-based heat-generating coating material, and then drying. The resistance heat-generating layer may be formed of a single kind of water-based heat-generating coating material or may be formed of multiple kinds of water-based heat-generating coating materials having different compositions. Furthermore, it may be a single layer or multiple layers where the coating material is applied multiple times. Since the heat-generating coating material used in the present invention is water-based, a burden on operators and the environment is low, and the coating material is excellent in safety without any risk of fire or explosion.

The layer structure and the method for producing the planar heat-generating element of the present invention are not limited to a particular structure or method, and the planar heat-generating element having a conventionally known layer structure may be produced in accordance with a conventional method. For example, the planar heat-generating element may be formed by laminating an insulating substrate, a resistance heat-generating layer, and an insulating protective layer in this order. In this case, the resistance heat-generating layer may be directly formed on the insulating substrate or may be formed on, for example, a strippable film and then transferred to the insulating substrate. The insulating substrate may be selected according to the purpose without particular restrictions, and may be sheets such as a film or fabric, or three-dimensional objects such as a pipe. The insulating substrate preferably includes microscopic asperities formed by processes such as embossing or surface-roughening of the surface to be coated so that the resistance heat-generating layer formed by the application of the water-based heat-generating coating material is brought into closer contact with the insulating substrate. Among these insulating substrates, sheet-shaped materials are preferred since the sheet-like materials can be wrapped around objects having a variety of shapes; fabric is more preferred since part of the water-based heat-generating coating material sinks into the fabric and becomes integrated with the insulating substrate, and glass fiber sheets are most preferred since the glass fiber sheets are inexpensive and have excellent heat resistance. Additionally, the insulating protective layer may be any of a film, a fabric, a porous sheet, a coating layer, etc., or two or more of these may be combined.

The planar heat-generating element of the present invention includes the resistance heat-generating layer containing water-swellable synthetic mica, which is inorganic. The inventors of the present invention found that the resistance heat-generating layer containing the water-swellable synthetic mica shows weak PTC properties. That is, the water-swellable synthetic mica achieves the effect of inhibiting the PTC properties of the resistance heat-generating layer. It is inferred that this is because since the water-swellable synthetic mica has lower volume expansion with increasing temperature as compared with a binder resin, the resistance heat-generating layer containing the water-swellable synthetic mica has lower fluctuation in the distance between conductive materials with increasing temperature, and this inhibits an increase in the resistance value.

In the planar heat-generating element of the present invention, since expression of the PTC properties of the resistance heat-generating layer is inhibited (increase in the resistance value with increasing temperature is inhibited), decrease in the current amount is small even at high temperatures. Furthermore, since the planar heat-generating element of the present invention includes the resistance heat-generating layer containing water-swellable synthetic mica, which is inorganic, the planar heat-generating element has excellent heat resistance. For this reason, the planar heat-generating element of the present invention including the resistance heat-generating layer is capable of generating high-temperature heat compared with conventional planar heat-generating elements, and can be used in applications that require a temperature of 150° C. or higher.

A lead wire for supplying electricity is connected to the resistance heat-generating layer. The method for connecting the lead wire to the resistance heat-generating layer is not limited to a particular method, and the lead wire can be connected by a conventional method. For example, a conventional method includes using fabric as an insulating substrate, and weaving the lead wire into the fabric as warps or wefts or sewing the lead wire to the fabric. In the present invention, the method for connecting the lead wire is preferably the method of placing the lead wire on the resistance heat-generating layer, covering the lead wire with a polymer film, which will be the insulating protective layer, and heat-sealing the polymer film by hot-pressing. With this method, part of the lead wire is embedded in the resistance heat-generating layer. This inhibits the lead wire from falling off, and further reduces the variation in the current amount at the connecting portion between the lead wire and the resistance heat-generating layer. The polymer film may be any film without particular restrictions as long as the polymer film can withstand a high temperature during hot-pressing or usage of the planar heat-generating element, and may be, for example, a fluorine-based film or a polyimide-based film. Also, the lead wire may be, for example, a metal wire such as copper wire, nickel wire, or copper-plated nickel stranded wire, or copper-plated aramid fibers, but is preferably an assembly of multiple fibers so that part of the lead wire is easily embedded in and integrated with the resistance heat-generating layer during hot-pressing.

The planar heat-generating element of the present invention includes the resistance heat-generating layer containing water-swellable synthetic mica, which is inorganic. Through repeatedly conducting experiments on heat-sealing the polymer film on the resistance heat-generating layer containing the water-swellable synthetic mica by hot-pressing, the present inventors found that the resistance value of the resistance heat-generating layer changes according to the pressure during pressing (the higher the pressure during pressing, the lower the resistance value becomes).

With the resistance heat-generating layer containing water-swellable synthetic mica, the resistance value of the resistance heat-generating layer changes according to the pressure during pressing, and specifically, the higher the pressing pressure, the lower the resistance value becomes. This property is seen only with the resistance heat-generating layer to which the water-swellable synthetic mica is added, and is not seen with the resistance heat-generating layer to which non-swellable synthetic mica or colloidal silica is added. Also, with the resistance heat-generating layer containing the water-swellable synthetic mica, the region in the resistance heat-generating layer that was pressed more strongly became thinner than other regions of the resistance heat-generating layer. Given the circumstances, the change in the resistance value of the resistance heat-generating layer depending on the pressure during the pressing of the resistance heat-generating layer containing the water-swellable synthetic mica is probably because the distance between the layers of the water-swellable synthetic mica was narrowed by the pressing, and thus the distance between the conductive materials was shortened.

The resistance value and the amount of heat generation of the planar heat-generating element of the present invention are reduced by pressing the resistance heat-generating layer after formation. That is, the upper limit of the temperature of the heat generated by the planar heat-generating element of the present invention is adjusted by, for example, the pressing pressure or the number of times of pressing. The pressing may be performed any time after the resistance heat-generating layer is formed and may be performed, for example, simultaneously as when the polymer film, which serves as the insulating protective layer, is heat-sealed by hot-pressing. Alternatively, the pressing may be performed before or after when the polymer film is heat-sealed, or may be performed multiple times. Thus, more strongly pressed low-resistance regions where the amount of heat generation is low and high-resistance region(s) where the amount of heat generation is high can be formed by pressing in a given pattern.

If the connecting portion between the lead wire and the resistance heat-generating layer of the planar heat-generating element are not in close contact with each other, a current is not uniformly conducted to the entire surface. Thus, a failure such as abnormal heat generation or a short circuit may occur at the faulty contact portion. Thus, preferably the resistance heat-generating layer that includes at least two low-resistance regions and at least one high-resistance region is used, and the lead wire is connected to the low-resistance regions. Connecting the lead wire to the low-resistance regions reduces variation in the resistance value even if there is a faulty contact portion, and thus allows relatively uniform conduction. The method for forming the low-resistance regions and the high-resistance region(s) is not limited to a particular method and may include, for example, a method that uses the water-based heat-generating coating materials having different resistance values and a method that sets the thickness of the low-resistance regions greater than that of the high-resistance region(s), which are conventionally known. Since the resistance heat-generating layer formed of the water-based heat-generating coating material of the present invention allows the low-resistance regions and the high-resistance region(s) to be formed by a simple method of pressing, preferably the method is used that forms the resistance heat-generating layer, which is a single coating layer, and then presses the sections that will be the low-resistance regions more strongly than the section that will be the high-resistance region. The method of strongly pressing some parts includes, for example, a method of pressing using a patterned mold or pressing using a plate-like mold with, for example, a metal foil or a polymer film placed on the section that is intended to be pressed with high pressure (the section that will be the low-resistance regions).

For a curved or bent part of, for example, a pipe, the planar heat-generating element needs to be bent in conformance with that part. The heat-generating element located on such part is apt to receive a kinetic load. Although the planar heat-generating element is apt to be disconnected in response to receiving the kinetic load, disconnection can be prevented by improving flexibility. Since the section of the planar heat-generating element of the present invention that is pressed with high pressure becomes thin and easy to bend, a planar heat-generating element that is flexible, easy to bend, and resists disconnection is obtained by pressing with high pressure.

### EXAMPLES

### Experiment 1

Inorganic particles and deionized water as shown below were added to the water-based heat-generating coating material containing carbon black and polyimide resin. The mixture was stirred for 6 minutes by a standard stirring and defoaming program for high-viscosity material using a planetary stirring/defoaming device (MAZERUSTAR KK-1000W manufactured by KURABO INDUSTRIES LTD.) to prepare the water-based heat-generating coating material.

The obtained water-based heat-generating coating material was applied on an insulating substrate (twill glass cloth manufactured by UNITIKA LTD.) using a doctor blade to a width of 150 mm, a length of 220 mm, and a coating amount (drying weight) of 55 g/m², followed by firing at 200° C. for 1 hour and subsequently at 300° C. for 1 hour to obtain the planar heat-generating element having the resistance heat-generating layer.

### Inorganic Particle

Water-swellable synthetic mica: average particle size of 5 μm

Non-swellable synthetic mica: average particle size of 5 μm

Colloidal silica: average particle size of 12 μm

Bentonite: average particle size of 2 μm

The obtained planar heat-generating element was evaluated as follows. The results are shown in Table 1.

### (Thixotropic Property)

The rear surface of the insulating substrate was visually observed to check whether the water-based heat-generating coating material had bled through. The coating material with a low thixotropic property bled through the insulating substrate.

O: No bleed-through

x: There is bleed-through

### (Coating Film Formation)

The front surface of the resistance heat-generating layer was visually observed to evaluate the uniformity of the coating film.

⊚: Uniform coating film was formed

O: Minute cracks were found

Δ: Large cracks were found

x: Inorganic particles have aggregated and a uniform coating film could not be formed

### (Flexibility)

The planar heat-generating element was bent by hand to evaluate the flexibility and the presence/absence of damage on the resistance heat-generating layer after bending.

O: Had flexibility, with no damage on the resistance heat-generating layer after bending.

x: Poor flexibility, or damage such as cracks were found on the resistance heat-generating layer after bending.

TABLE 1

| | | | | |
|---|---|---|---|---|
| Example 1 | Example 2 | Example 3 | Example 4 | Example 5 |

| | |
|---|---|
| Inorganic | Water-swellable synthetic mica |
| particles | |

| | | | | | |
|---|---|---|---|---|---|
| Inorganic | 6 wt % | 11 wt % | 16 wt % | 24 wt % | 34 wt % |
| particles/solid | | | | | |
| content | | | | | |
| Conductive | 57 wt % | 54 wt % | 51 wt % | 46 wt % | 40 wt % |
| material | | | | | |
| amount/solid | | | | | |
| content | | | | | |
| Binder | 37 wt % | 35 wt % | 33 wt % | 30 wt % | 26 wt % |
| resin/solid | | | | | |
| content | | | | | |
| Thixotropic | ◯ | ◯ | ◯ | ◯ | ◯ |
| property | | | | | |
| Coating film | ◯ | ⊚ | ⊚ | ⊚ | ⊚ |
| formation | | | | | |
| Flexibility | ◯ | ◯ | ◯ | ◯ | ◯ |
| Overall | ◯ | ◯ | ◯ | ◯ | ◯ |
| evaluation | | | | | |

| | Comparative | Comparative | Comparative | Comparative | Comparative | Comparative | Comparative | Comparative |
|---|---|---|---|---|---|---|---|---|
| | Example 1 | Example 2 | Example 3 | Example 4 | Example 5 | Example 6 | Example 7 | Example 8 |
| Inorganic | Non-swellable synthetic | | Colloidal silica | | None | Bentonite | | |
| particles | mica | | | | | | | |
| Inorganic | 12 wt % | 16 wt % | 7 wt % | 16 wt % | 0 wt % | 6 wt % | 12 wt % | 18 wt % |
| particles/solid | | | | | | | | |
| content | | | | | | | | |
| Conductive | 53 wt % | 51 wt % | 56 wt % | 51 wt % | 61 wt % | 57 wt % | 53 wt % | 50 wt % |
| material | | | | | | | | |
| amount/solid | | | | | | | | |
| content | | | | | | | | |
| Binder | 35 wt % | 33 wt % | 37 wt % | 33 wt % | 39 wt % | 37 wt % | 35 wt % | 32 wt % |
| resin/solid | | | | | | | | |
| content | | | | | | | | |
| Thixotropic | ◯ | ◯ | X | X | X | ◯ | ◯ | ◯ |
| property | | | | | | | | |
| Coating film | ◯ | ⊚ | Δ | Δ | Δ | X | X | X |
| formation | | | | | | | | |
| Flexibility | X | X | X | X | X | X | X | X |
| Overall | X | X | X | X | X | X | X | X |
| evaluation | | | | | | | | |

Result

The water-based heat-generating coating materials of Examples 1 to 5 according to the present invention had thixotropic property. Also, with these water-based heat-generating coating materials, coating films were formed that were uniform, flexible, and would not be damaged after being bent.

The water-based heat-generating coating materials of Comparative Examples 1 and 2 that used non-swellable synthetic mica had thixotropic property. With the water-based heat-generating coating materials of Comparative Examples 1 and 2, although coating films could be formed, the obtained coating films had poor flexibility, and cracks increased after being bent.

The water-based heat-generating coating materials that used colloidal silica according to Comparative Examples 3 and 4, and the water-based heat-generating coating material that did not contain inorganic particles according to Comparative Example 5, did not have thixotropic property, and bled through gaps in the insulating substrate (twill glass cloth). Thus, a flat coating film could not be formed. Also, the region where the coating film was partially formed had large cracks, and, moreover, the cracks increased after being bent.

The water-based heat-generating coating materials that used bentonite according to Comparative Examples 6 and 7 had thixotropic property, but the aggregation of bentonite was visually observed on the obtained coating films. Additionally, large cracks were observed, and flexibility was poor.

### Experiment 2

The water-based heat-generating coating materials of Example 3 and Comparative Examples 2, 4, and 5 of Experiment 1 were used to form resistance heat-generating layers by the method that was the same as the above Experiment 1.

Four 50×50 mm² samples were cut out from the central part across the width of the resistance heat-generating layers. Each sample was sandwiched between fluororesin sheets (DAIKIN INDUSTRIES, Ltd., NEOFLON series, PFA, 12 μm) and was hot-pressed using a hot press machine with pressure in 10 kN increments from 20 to 50 kN, at 300° C. for 20 minutes. Note that the fluororesin sheets on the resistance heat-generating layer included φ5 mm holes formed at 40 mm intervals for measuring the resistance value.

The surface of the resistance heat-generating layer after hot-pressing was observed with an optical microscope through the fluororesin sheets. Additionally, the resistance value was measured by a two-terminal method using mΩ HiTESTER (HIOKI E.E. CORPORATION, 3540).

Furthermore, samples that had been pressurized in 10 kN increments from 20 to 50 kN were each hot-pressed at 300° C. for 20 minutes with a pressure of 60, 80, 100, and 130 kN. Each resistance heat-generating layer was observed, and the resistance value was measured.

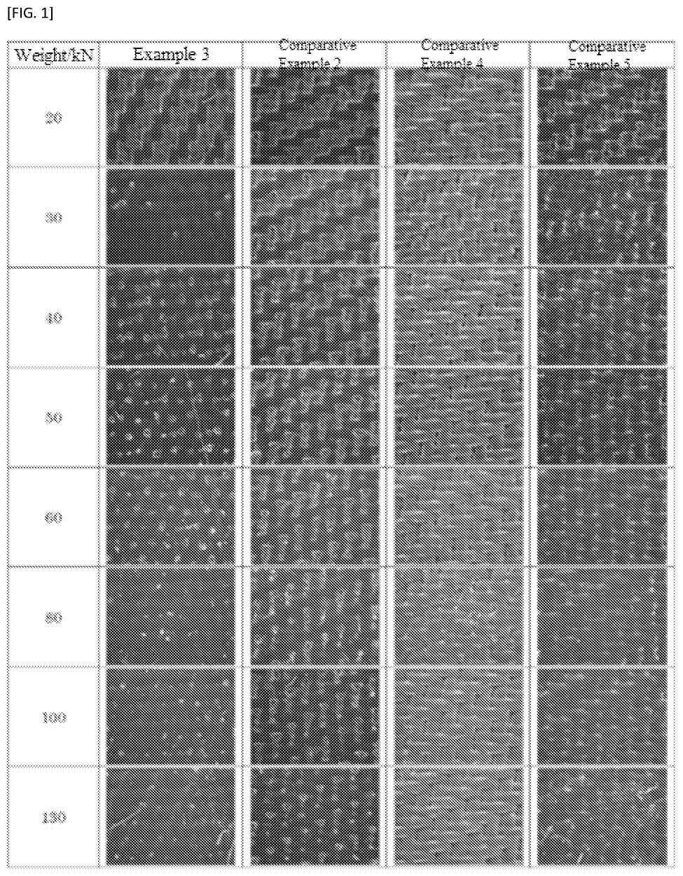

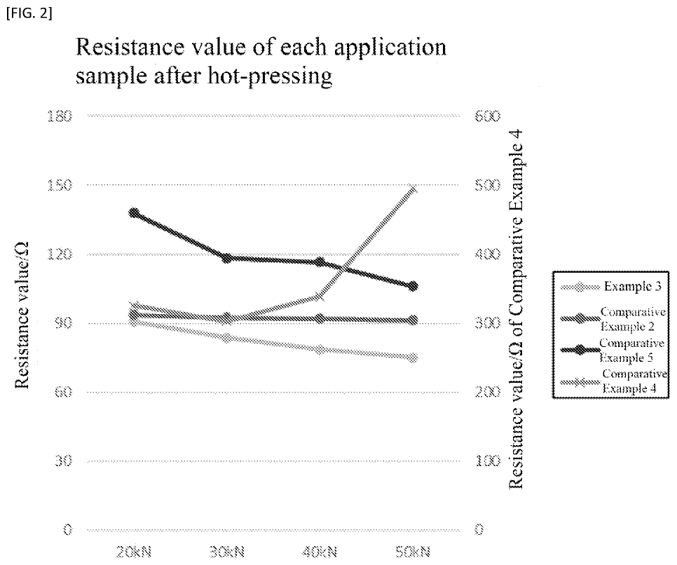

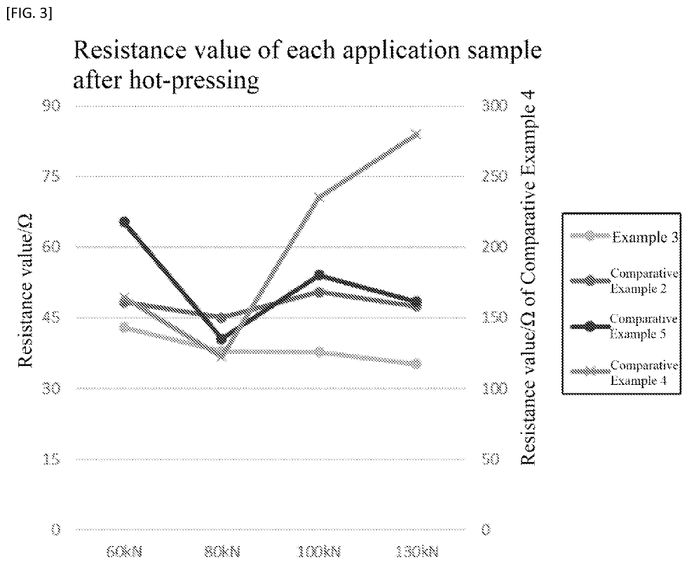

FIG. 1 shows optical microscope images, and FIGS. 2 and 3 show the relationship between the pressing pressure and the resistance value.

Compared with other resistance heat-generating layers, the resistance heat-generating layer formed of the water-based heat-generating coating material of Example 3 of the present invention was in close contact with the fluororesin sheet, indicating that it can be firmly brought into close contact with an insulating protective layer such as a fluororesin sheet. Also, this resistance heat-generating layer had the tendency that the resistance value decreases as the pressing pressure increases.

The resistance value of the resistance heat-generating layer formed of the water-based heat-generating coating material of Comparative Example 2 hardly changed relative to the pressing pressure, and the resistance value of the resistance heat-generating layer formed of the water-based heat-generating coating material of Comparative Example 4 increased with an increase in the pressing pressure. This is because cracks were formed on the coating film. The resistance value of the water-based heat-generating coating material of Comparative Example 4 was excellent compared with other coating materials. This is probably because since colloidal silica was used as the inorganic pigment, conductive particles could not enter the gaps between the layers as in the case of mica, and the distance between the conductive particles was great.

The resistance value of the resistance heat-generating layer formed of the water-based heat-generating coating material of Comparative Example 5 reduced at low pressures but increased with a pressure of 80 kN or more since cracks were formed on the coating film.

### Experiment 3

The water-based heat-generating coating materials of Example 3 and Comparative Examples 2, 4, and 5 were used to form resistance heat-generating layers by the method that was the same as the above Experiment 1.

The resistance heat-generating layers were cut into a size of 150 mm in width and 100 mm in length, and copper-coated aramid fibers having a length of 130 mm (URASE. Co., Ltd., F11) was placed on the resistance heat-generating layers at intervals of 100 mm in the width direction. The copper-coated aramid fibers were secured with fluororesin adhesive tape (AFA-113A, PFA, having a thickness of 200 μm, a width of 5 mm, and a length of 110 mm, manufactured by CHUKOH CHEMICAL INDUSTRIES, LTD.). Furthermore, they were each sandwiched between fluororesin sheets (DAIKIN INDUSTRIES, Ltd., NEOFLON series, PFA, 12 μm) and were hot-pressed using a hot press machine with a pressure of 50 kN at 300° C. for 20 minutes to obtain planar heat-generating elements. It should be noted that, in the present description below, the obtained planar heat-generating elements are given the same Example number and Comparative Example number as the coating materials to help understand the water-based heat-generating coating material used.

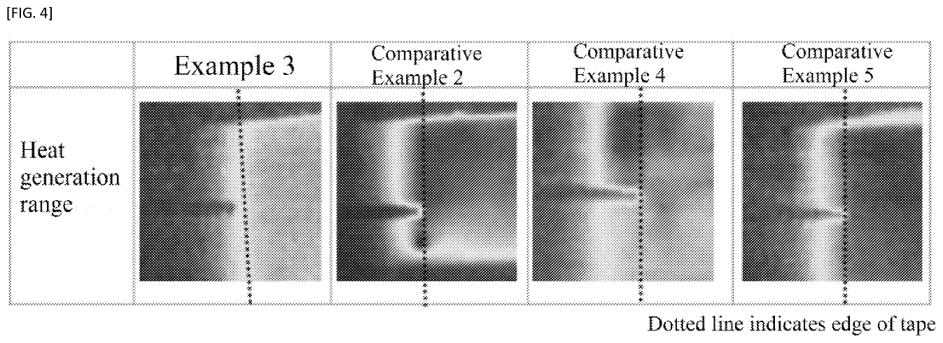

The heat generation properties of the obtained planar heat-generating elements were recorded by thermography when under a current supply of 0.3 W/cm². The results are shown in FIG. 4.

The planar heat-generating element of Example 3 generated heat at the section where the fluororesin adhesive tape adhered, and other samples generated heat at the section where the lead wire was located. That is, the resistance heat-generating layer of the present invention allowed the low-resistance regions and the high-resistance region(s) to be formed by only securing the lead wire with tape, and pressing and the lead wire to be connected to these low-resistance regions.

Furthermore, when a voltage was applied to the planar heat-generating element that used the water-based heat-generating coating material of Example 3 so that the highest temperature within the heat generation range was 200° C., and the application of the certain voltage was continued, the heat was kept generating for 340 days or more. It should be noted that the average temperature in the heat generation range was approximately 180° C. in summer and approximately 160° C. in winter.

The heat was kept generating without malfunction for a long period because the lead wire was connected to the low-resistance regions of the planar heat-generating element, which inhibited the occurrence of, for example, abnormal heat generation or a short circuit at the connecting portion between the lead wire and the resistance heat-generating layer.

### Experiment 4

The water-based heat-generating coating material of Example 3 was used to form a planar heat-generating element by the method that was the same as Experiment 3.

The planar heat-generating element was cut into a 20 mm² square sample. The sample was sealed with epoxy resin, which was then polished using an automatic polisher (BUEHLER, AutoMet 2000) to obtain a specimen for observation.

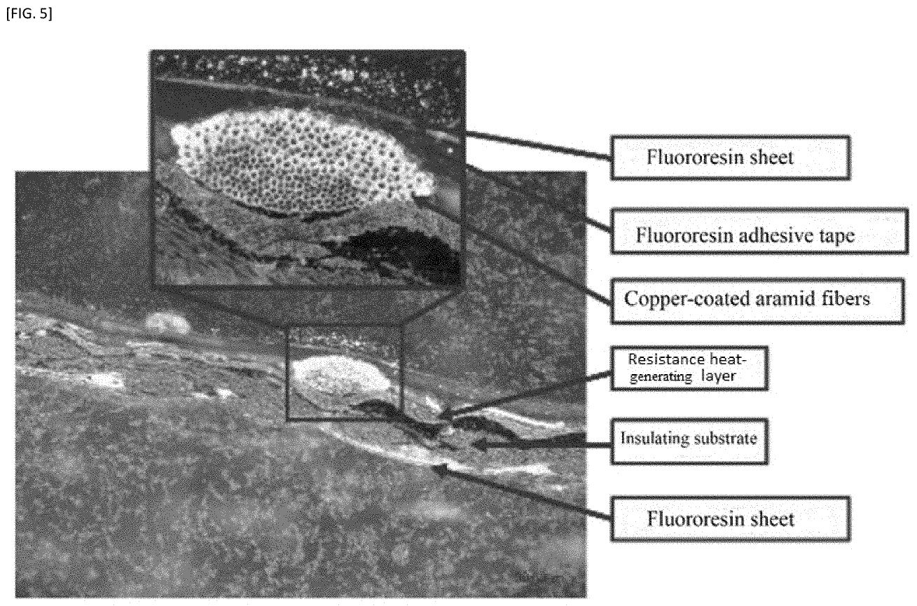

The cross-section of the specimen for observation was observed with an optical microscope. FIG. 5 shows a photo of a cross-section of the portion where copper-coated aramid fibers were located.

The resistance heat-generating layer was observed in a black band-like form below the copper-coated aramid fibers, and further below this was observed an insulating substrate (twill glass cloth). Transparent fluororesin tape was observed on the copper-coated aramid fibers, and further, observed on top of this was a translucent band-like fluororesin sheet. It was verified that the copper-coated aramid fibers were crushed to be in close contact with the resistance heat-generating layer. It was also verified that the resistance heat-generating layer was in close contact with the fluororesin sheet on the top face.

Furthermore, cross-sectional images were taken at three random locations in the region where the fluororesin adhesive tape was provided and the region where the fluororesin adhesive tape was not provided. The thickness of the resistance heat-generating layer between the fluororesin sheet and the glass cloth substrate was measured on these cross-sectional images, and the average value of the thicknesses was obtained.

The average thickness of the region where the fluororesin adhesive tape was provided was 88.5 μm, and the average thickness of the region where the fluororesin adhesive tape was not provided was 312.4 μm. The region where the fluororesin adhesive tape was provided was hot-pressed on the fluororesin adhesive tape and the fluororesin film (total thickness of 212 μm), and the region where the fluororesin adhesive tape was not provided was hot-pressed on only the fluororesin film (thickness of 12 μm). It was verified that the thickness of the region of the resistance heat-generating layer where the fluororesin adhesive tape was provided became thinner with stronger compression compared with the region where the fluororesin adhesive tape was not provided.

### Experiment 5

The water-based heat-generating coating material of Example 3 was used to form a planar heat-generating element by the method that was the same as the above Experiment 3 except that a nickel stranded wire was used as the lead wire, and the lead wire was not secured with the fluororesin adhesive tape.

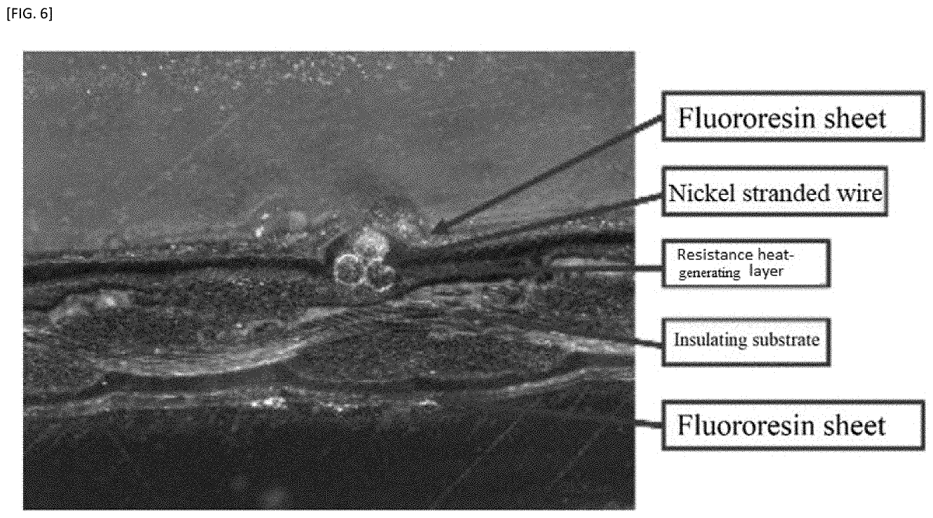

The cross-section was observed with the optical microscope in the same manner as the above Experiment 4. FIG. 6 shows a photo of the cross-section of the portion where the nickel stranded wire was located.

The section where three circles gather corresponds to the nickel stranded wires. The resistance heat-generating layer and the insulating substrate (twill glass cloth, an ellipse is the warp, a laterally wavy line is the weft) were observed below the nickel strand, and the fluororesin sheet was observed above the nickel strand. The nickel strand was partially embedded in the resistance heat-generating layer, and thus it was verified that the lead wire was in close contact with the resistance heat-generating layer.

### Experiment 6

The planar heat-generating element was formed by the method that was the same as the above Experiment 3 except that the lead wire was not secured with fluororesin adhesive tape, and the hot pressing was performed with a SUS foil (100 μm) that was cut into a heart shape placed on the fluororesin sheet on the resistance heat-generating layer side.

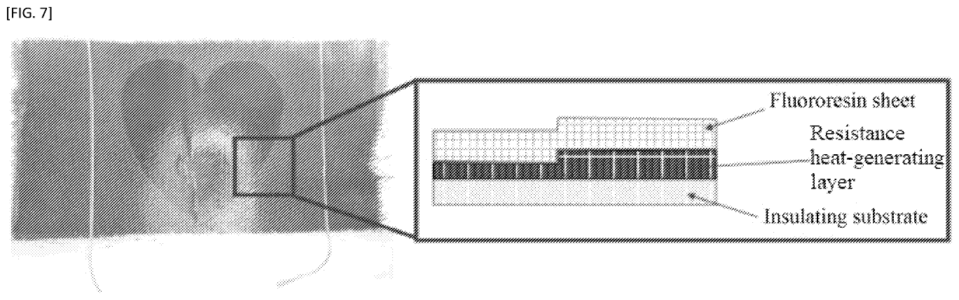

FIG. 7 is a photo and a schematic cross-sectional view of the produced planar heat-generating element.

The portion where the SUS foil was located was more strongly pressed, so that the gap with respect to the fluororesin sheet was reduced. Thus, a portion with different reflectance was formed corresponding to the shape of the SUS foil.

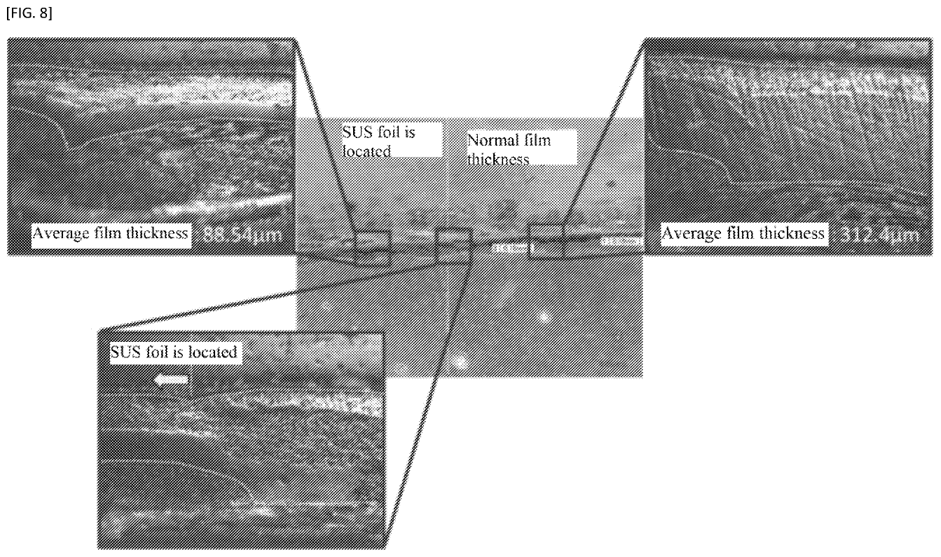

At the boundary portion of the sample where the SUS foil was located, cross-sectional images were taken at three random locations. The thickness of the resistance heat-generating layer between the fluororesin sheet and the glass cloth substrate was measured on these cross-sectional images, and the average value of the thicknesses was obtained. FIG. 8 shows one of the images.

The average thickness of the region of the resistance heat-generating layer where the SUS foil was provided was 88.54 μm, and the average thickness of the region of the resistance heat-generating layer where the SUS foil was not provided was 312.4 μm. The region where the SUS foil was provided was hot-pressed on the SUS foil and the fluororesin film (total thickness of 112 μm), and the region where the SUS foil was not provided was hot-pressed on only the fluororesin film (thickness of 12 μm). It was verified that the thickness of the region of the resistance heat-generating layer where the SUS foil was provided became thinner with stronger compression compared with the region where the SUS foil was not provided.

1. A water-based heat-generating coating material characterized by comprising a conductive material, a binder resin, and water-swellable synthetic mica,
wherein the water-swellable synthetic mica is contained by 3 parts by weight or more and 40 parts by weight or less relative to 100 parts by weight of solid content.

2. The water-based heat-generating coating material according to claim 1, characterized in that the conductive material is contained by 30 parts by weight or more and 70 parts by weight or less, and the binder resin is contained by 15 parts by weight or more and 50 parts by weight or less relative to 100 parts by weight of solid content.

3. The water-based heat-generating coating material according to claim 1, characterized in that the binder resin is any one or more of a polyimide resin, a silicone resin, and a polyamide resin.

4. A planar heat-generating element comprising a resistance heat-generating layer constituted by the water-based heat-generating coating material according to claim 1.

5. The planar heat-generating element according to claim 4, characterized in that
the resistance heat-generating layer includes at least two low-resistance regions and at least one high-resistance region, and
a lead wire is connected to the low-resistance regions.

6. The planar heat-generating element according to claim 5, characterized in that a film thickness of the low-resistance regions is thinner than a film thickness of the high-resistance region.

7. The planar heat-generating element according to claim 4, characterized in that the resistance heat-generating layer is a single coating layer.

8. The water-based heat-generating coating material according to claim 2, characterized in that the binder resin is any one or more of a polyimide resin, a silicone resin, and a polyamide resin.

9. A planar heat-generating element comprising a resistance heat-generating layer constituted by the water-based heat-generating coating material according to claim 2.

10. A planar heat-generating element comprising a resistance heat-generating layer constituted by the water-based heat-generating coating material according to claim 3.

11. The planar heat-generating element according to claim 5, characterized in that the resistance heat-generating layer is a single coating layer.

12. The planar heat-generating element according to claim 6, characterized in that the resistance heat-generating layer is a single coating layer.
